(19) United States
(12) Patent Application Publication
(10) Pub. No.: US 2026/0181369 A1
(43) Pub. Date: Jun. 25, 2026

(54) INFORMATION PROCESSING APPARATUS, CONTROL METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventors: NATSUMI KIKUTA, Tokyo (JP); HIROYOSHI IWAYAMA, Kanagawa (JP); KEISUKE MIZUTANI, Kanagawa (JP)

(21) Appl. No.: 19/426,534

(22) Filed: Dec. 19, 2025

(30) Foreign Application Priority Data
Dec. 25, 2024 (JP) 2024-229382

(51) Int. Cl. H04W 8/00; H04W 4/06; H04W 12/069

(52) U.S. Cl. CPC H04W 8/005; H04W 4/06; H04W 12/069

(57) ABSTRACT

An information processing apparatus executes first search processing as processing of searching for a communication apparatus belonging to a network formed by an access point to which the information processing apparatus is connected; executes, based on a fact that no communication apparatus is discovered by the first search processing, second search processing as processing of searching for a registered communication apparatus in a predetermined cloud server system capable of communicating via the Internet; and executes, via communication with the predetermined cloud server system, communication with a communication apparatus discovered by the second search processing.

### BACKGROUND

### Field of the Technology

The present disclosure relates to an information processing apparatus capable of communicating with an access point, a control method executed by the information processing apparatus, and a non-transitory computer-readable storage medium storing a program.

### Description of the Related Art

To execute printing from a client terminal such as a PC or a smartphone, it is necessary to allow a printer already connected to a network to communicate with the client terminal. An application on the client terminal searches for printers connected to the same network as that of the client terminal, and a printer selected by the user from a search result is registered in the application.

On the other hand, in a state in which various kinds of devices are connected to a Wi-Fi access point, it is possible to perform communication with another device, which may be a security risk. In the settings of the access point, there is known a network separator function that prevents communication between devices and only allows each device to communicate with the external Internet.

Japanese Patent Laid-Open No. 2022-40993 describes that when a printer registered in a cloud service is selected as an output destination of printing, printing is executed by communication via a LAN in an environment where devices can communicate with each other, and is executed via the Internet in an environment where devices cannot communicate with each other.

When an information processing apparatus searches, via an access point, for a communication apparatus connected to the access point, even the communication apparatus connected to the access point may not be discovered depending on the settings of the access point. In this case, the user cannot use the communication apparatus from the information processing apparatus.

### SUMMARY

The present disclosure provides an information processing apparatus that makes it possible to discover a communication apparatus connected to an access point regardless of the settings of the access point, a control method, and a non-transitory computer-readable storage medium storing a program.

The present disclosure in one aspect provides a control method for an information processing apparatus, comprising: executing first search processing as processing of searching for a communication apparatus belonging to a network formed by an access point to which the information processing apparatus is connected; executing, based on a fact that no communication apparatus is discovered by the first search processing, second search processing as processing of searching for a registered communication apparatus in a predetermined cloud server system capable of communicating via the Internet; and executing, via communication with the predetermined cloud server system, communication with a communication apparatus discovered by the second search processing.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing the configuration of a communication system;

FIG. 2 is a block diagram showing the configurations of apparatuses;

FIG. 3 is a flowchart illustrating processing in an information processing apparatus;

FIG. 4 is a flowchart illustrating the processing in the information processing apparatus;

FIG. 5 is a flowchart illustrating the processing in the information processing apparatus;

FIGS. 6A and 6B are views each showing a user interface screen;

FIGS. 7A and 7B are views each showing a user interface screen;

FIG. 8 is a view showing a user interface screen;

FIGS. 9A and 9B are tables each showing registration information;

FIG. 10 is a view showing a user interface screen;

FIGS. 11A and 11B are views each showing a user interface screen;

FIG. 12 is a view showing a user interface screen;

FIG. 13 is a flowchart illustrating processing in the information processing apparatus;

FIGS. 14A to 14E are views each showing a user interface screen; and

FIGS. 15A and 15B are views each showing a user interface screen.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

According to the present disclosure, it is possible to discover a communication apparatus connected to an access point regardless of the settings of the access point.

### Communication System

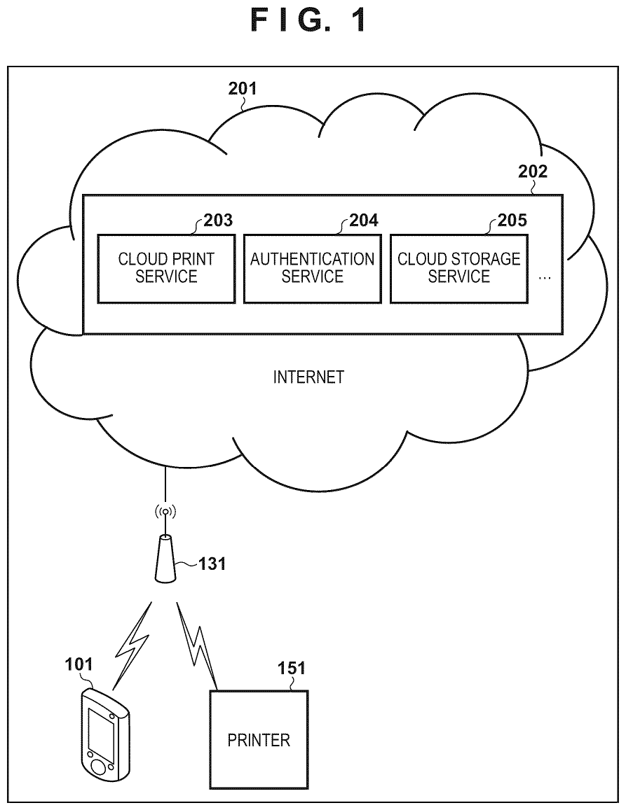

A cloud server system and an information processing apparatus and a communication apparatus included in a communication system according to this embodiment will be described. FIG. 1 is a view showing an example of the communication system. In this embodiment, a smartphone is exemplified as an information processing apparatus 101 shown in FIG. 1, but the present disclosure is not limited to this and various kinds of apparatuses such as a portable terminal, a notebook PC, a tablet terminal, a Personal Digital Assistant (PDA), and a digital camera are applicable. As a communication apparatus 151, various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a scanner, a copying machine, a facsimile apparatus, a portable terminal, a smartphone, a notebook PC, a tablet terminal, a PDA, a digital camera, a music playback device, a television, a smart speaker, and the like are applicable. In addition, a multi-function peripheral having a plurality of functions such as a copying function, a FAX function, a print function, and a scanner function is also applicable. In this embodiment, the communication apparatus 151 is assumed to be a multi-function printer having a print function and a scanner function.

An access point 131 shown in FIG. 1 is a network device to which the information processing apparatus 101 and the communication apparatus 151 are connectable. The access point 131 is connected to a network 201 such as the Internet. The information processing apparatus 101 and the communication apparatus 151 can communicate with a cloud server system 202 via the access point 131. Note that the cloud server system 202 can be formed by one or a plurality of server apparatuses.

Subsequently, cloud services provided to a customer by the cloud server system 202 will be described. The cloud server system 202 provides, to an organization such as a company, a cloud print service, a cloud storage service, a Web mail service, a document creation and editing service, and the like. Note that the cloud server system 202 need not provide all these cloud services, and may provide only some of the cloud services. The cloud server system also provides an authentication service for authenticating and managing devices and users that use various kinds of services. Therefore, the cloud server system 202 includes a cloud print service 203 that is a software module for providing a cloud print service, an authentication service 204 that is a software module for providing an authentication service, and a cloud storage service 205 that is a software module for providing a cloud storage service.

The authentication service 204 authenticates and manages a device for each user. The cloud server system 202 manages, for each user, use authority of a cloud service and access to customer data. A communication apparatus 151 registered in the cloud print service 203 is managed for each user. Note that the cloud server system 202 may manage a communication apparatus 151 for each tenant. In this form, a different tenant is assigned to each organization (for example, each company or each organization) that has made a usage contract of the cloud server system 202. Then, the cloud server system 202 performs management by linking a communication apparatus 151 with each assigned tenant. In this form, user data including print data, data necessary to implement the cloud print service 203, and a user database (DB) for user authentication are managed for each tenant. This embodiment assumes a form in which a communication apparatus 151 is managed for each tenant. The cloud print service 203 has a function of temporarily holding a print job received from the outside, and a function of transmitting the held print job to the communication apparatus registered in the cloud print service 203. The communication apparatus registered in the cloud print service 203 will be referred to as a cloud printer hereinafter.

The cloud server system 202 receives a print job from a client terminal such as the information processing apparatus 101, and stores the print job in a holding area managed by itself. Subsequently, the cloud server system 202 notifies the communication apparatus 151 registered in the cloud print service 203 of the input of the print job. Upon receiving the notification, the communication apparatus 151 acquires the print job from the holding area of the cloud server system 202, and executes printing based on the acquired print job.

### Hardware Configuration of Each Apparatus

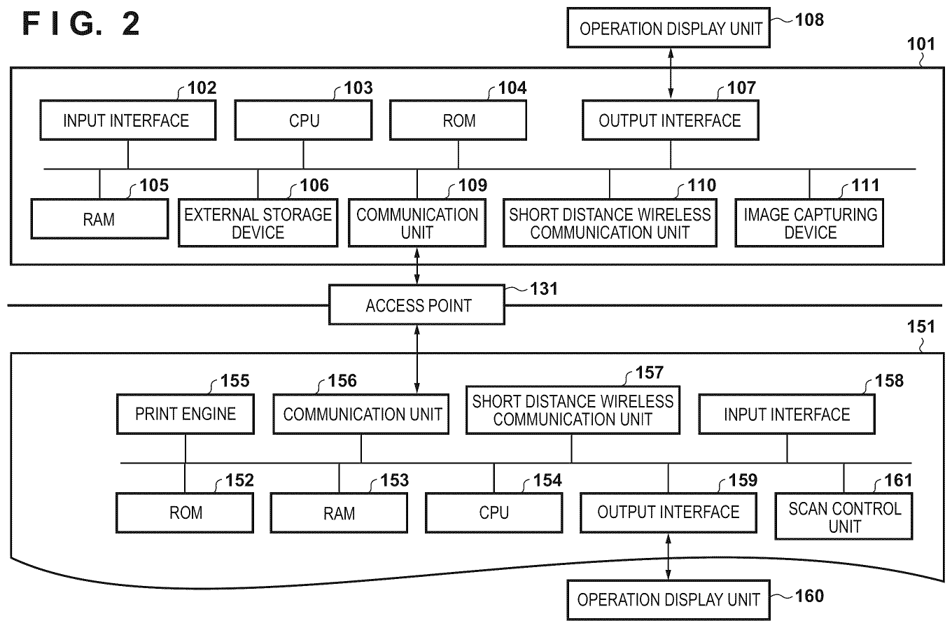

The configuration of the information processing apparatus 101 included in the communication system according to this embodiment, and that of a communication apparatus 151 capable of communicating with the information processing apparatus 101 will be explained with reference to the block diagram of FIG. 2. The following configurations will be exemplified in this embodiment, but the present disclosure is not limited to those shown in FIG. 2, and each apparatus can appropriately have a configuration corresponding to a function that can be implemented by the apparatus.

The information processing apparatus 101 includes an input interface 102, a CPU 103, a ROM 104, a RAM 105, an external storage device 106, an output interface 107, an operation display unit 108, a communication unit 109, a short distance wireless communication unit 110, and an image capturing device 111. The input interface 102 is an interface configured to accept a data input and an operation instruction from the user, and is formed by a physical keyboard, display buttons, a touch panel, and the like. Note that the output interface 107 and the input interface 102 (to be described later) may have the same configuration, and output of a screen and acceptance of an operation from the user may be done by the same configuration.

The CPU 103 is a system control unit and controls the whole information processing apparatus 101. The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104.

The RAM 105 is formed by a Static Random Access Memory (SRAM) or the like, which needs a backup power supply. Note that the RAM 105 can store important data such as program control variables without losing the data because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and work memory of the CPU 103.

The external storage device 106 includes a communication application program (to be described as a communication application hereinafter) having a function of allowing the apparatus to communicate with the communication apparatus 151 and a function of executing connection setting processing for connecting the communication apparatus 151 to an external access point. The communication application operates on the CPU 103. In addition to the communication application, the external storage device 106 stores an application having a print function for causing the communication apparatus 151 to execute printing, and a scan function for causing the communication apparatus 151 to execute scanning. However, the application is not limited to this form, and may be an application having either of the print function and the scan function, or an application having another function. For example, the application may be, for example, the above-described communication application. The external access point is, for example, the access point 131 to be described later.

The external storage device 106 also has various programs such as a print information generation program for generating print information interpretable by the communication apparatus 151, an information transmission/reception control program for performing transmission/reception to/from the communication apparatus 151 connected via the communication unit 109, and a user management program for storing an access token as the user account information of the cloud server system 202. These programs may be programs included in the above-described application or programs configured separately from the application. Note that the access token is provided from the cloud server system 202 to the information processing apparatus 101 when the information processing apparatus 101 logs in to the cloud server system 202. Furthermore, the access token is information generated by the cloud server system 202 based on the user account information used for the login processing. The external storage device 106 stores various kinds of information to be used by these programs. The external storage device 106 also stores image data obtained from another information processing apparatus or the Internet via the communication unit 109.

This embodiment will exemplify a case where the information processing apparatus 101 is authenticated by the authentication service 204 of the cloud server system 202, and undergoes device management. Assume that login authentication of the user who uses the information processing apparatus 101 is performed in cooperation with the authentication service 204 of the cloud server system 202.

In this embodiment, the communication application acquires the access token corresponding to the login user from the external storage device 106. Subsequently, the communication application uses the access token to invoke a Web API provided by the cloud print service 203. Upon accepting the invocation of the Web API, based on the access token, the cloud print service 203 returns information of a cloud printer associated with the login user and information of the usable cloud storage service 205. For example, if the cloud print service 203 receives a request including the access token corresponding to the login user, it notifies the communication application of a list of cloud printers and a list of cloud storage services associated with the user.

The output interface 107 is an interface that performs display control for causing the operation display unit 108 to perform display of data and notification of the state of the information processing apparatus 101. The operation display unit 108 is formed by a Light-Emitting Diode (LED), a Liquid Crystal Display (LCD), or the like, and performs display of data and notification of the state of the information processing apparatus 101. Note that a software keyboard including keys such as numerical input keys, a mode setting key, an OK key, a cancel key, and a power key may be provided on the operation display unit 108 so that an input from the user is accepted via the operation display unit 108.

The communication unit 109 is configured to be connected to an apparatus such as the communication apparatus 151 to execute data communication. For example, the communication unit 109 can be connected to an access point (not shown) in the communication apparatus 151. When the communication unit 109 and the access point in the communication apparatus 151 are connected to each other, the information processing apparatus 101 and the communication apparatus 151 can communicate with each other. The access point will sometimes be referred to as an AP hereinafter. Note that the communication unit 109 may directly communicate with the communication apparatus 151 by wireless communication, or may communicate with the communication apparatus 151 via the access point 131 external to the information processing apparatus 101 and the communication apparatus 151. As the wireless communication method, the IEEE 802.11 communication standard is used in this embodiment. Note that the IEEE 802.11 communication standard is Wi-Fi®. The communication unit 109 can communicate with the cloud server system 202 via the access point 131.

As the access point 131, for example, a device such as a wireless LAN router can be used. Note that in this embodiment, a method of connecting the information processing apparatus 101 and the communication apparatus 151 directly without intervention of the external access point will be referred to as a direct connection method hereinafter. In addition, a method of connecting the information processing apparatus 101 and the communication apparatus 151 via the external access point 131 will be referred to as an infrastructure connection method hereinafter.

The short distance wireless communication unit 110 is configured to be connected to an apparatus such as the communication apparatus 151 by short distance wireless communication and execute data communication, and performs communication by a communication method different from that of the communication unit 109. The short distance wireless communication method used by the short distance wireless communication unit 110 is, for example, Bluetooth® or Near Field Communication (NFC). Bluetooth may be Bluetooth Classic or Bluetooth Low Energy. The short distance wireless communication unit 110 can be connected to a short distance wireless communication unit 157 in the communication apparatus 151.

The image capturing device 111 is a device that converts an image captured by an image sensor into digital data. The digital data is temporarily stored in the RAM 105. Then, the digital data is converted into a predetermined image format by a program executed by the CPU 103, and stored as image data in the external storage device 106.

The communication apparatus 151 includes a ROM 152, a RAM 153, a CPU 154, a print engine 155, a communication unit 156, the short distance wireless communication unit 157, an input interface 158, an output interface 159, an operation display unit 160, and a scan control unit 161. When a connection mode is set, the communication apparatus 151 can operate in the set connection mode. The connection mode is, for example, a mode for communication by direct connection or a mode for communication by infrastructure connection.

The communication unit 156 is configured to allow the communication apparatus 151 to communicate with another apparatus. In this embodiment, the communication unit 156 performs communication in accordance with the IEEE 802.11 communication standard. The communication unit 156 includes, as an access point in the communication apparatus 151, an access point for performing connection to an apparatus such as the information processing apparatus 101. Note that the access point can be connected to the communication unit 109 of the information processing apparatus 101. Note also that the communication unit 156 may directly communicate with the information processing apparatus 101 by wireless communication, or may communicate with the information processing apparatus 101 via the access point 131. The communication unit 156 may include hardware functioning as an access point, or operate as an access point by software for causing the communication unit 156 to function as an access point. Note that in this embodiment, the communication unit 156 and the short distance wireless communication unit 157 are implemented by one radio chip. That is, in this embodiment, a combo chip corresponding to both a communication function based on the IEEE 802.11 communication standard and a communication function based on the short distance wireless communication method is used. However, the present disclosure is not limited to this form, and the communication unit 156 and the short distance wireless communication unit 157 may be implemented by separate radio chips.

The RAM 153 is formed by a DRAM or the like that needs a backup power supply. Note that the RAM 153 can store important data such as program control variables without volatilization because the data are held by supplying power (not shown) for data backup. Furthermore, the RAM 153 is used as the main memory and work memory of the CPU 154, operates as a reception buffer for temporarily storing print information received from the information processing apparatus 101 or the like, and stores various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151. Based on the information stored in the RAM 153 or a print job received from the information processing apparatus 101 or the like, the print engine 155 forms an image on a print medium such as a paper sheet using a printing material such as ink and outputs the print result. At this time, the print job transmitted from the information processing apparatus 101 or the like has a large transmission data amount, and high-speed communication is required. Thus, the print engine 155 receives the print job via the communication unit 156 capable of performing communication at a higher speed than the short distance wireless communication unit 157.

The short distance wireless communication unit 157 is configured to be connected to an apparatus such as the information processing apparatus 101 by short distance wireless communication and execute data communication, and performs communication by a communication method different from that of the communication unit 156. The short distance wireless communication method used in the short distance wireless communication unit 157 is, for example, Bluetooth® or NFC. Bluetooth may be Bluetooth Classic or Bluetooth Low Energy. The short distance wireless communication unit 157 can be connected to the short distance wireless communication unit 110.

The input interface 158 is an interface configured to accept a data input and an operation instruction from the user, and is formed by a physical keyboard, buttons, a touch panel, and the like. Note that the output interface 159 (to be described later) and the input interface 158 may have the same configuration, and output of a screen and acceptance of an operation from the user may be done by the same configuration. The output interface 159 is an interface that performs display control for causing the operation display unit 160 to perform display of data and notification of the state of the communication apparatus 151.

The operation display unit 160 is formed by a display unit such as a Light-Emitting Diode (LED) or a Liquid Crystal Display (LCD), and performs display of data and notification of the state of the communication apparatus 151. Note that a software keyboard including keys such as numerical input keys, a mode setting key, an OK key, a cancel key, and a power key may be provided on the operation display unit 160 so that an input from the user is accepted via the operation display unit 160.

The scan control unit 161 includes an image sensor unit (reading unit) that executes scanning of a document set on a document table or an Automatic Document Feeder (ADF) (not shown). Note that the image sensor unit includes a light source configured to irradiate a document with light, and an image sensor having an array of elements configured to read the reflected light and photoelectrically convert it. The scan control unit 161 acquires image data by analog/digital (A/D)-converting an analog electrical signal obtained by reading a document by the image sensor unit. The scan control unit 161 also includes a circuit configured to perform direct memory access (DMA) transfer in order to store the acquired image data in the RAM 153.

### Direct Connection Method

Direct connection indicates a form in which apparatuses are wirelessly connected directly (that is, by Peer to Peer) without intervention of an external apparatus such as the access point 131. As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct® mode. Wi-Fi Direct will be referred to as WFD hereinafter.

A mode in which direct connection is executed by WFD is called a WFD mode. WFD is a standard developed by Wi-Fi Alliance and is a standard included in the IEEE 802.11 communication standards. In the WFD mode, a device serving as a communication partner is searched for by device search information, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, Go Negotiation in P2P. Note that in the WFD mode in a state before role making is performed, the communication apparatus 151 is neither the master station nor the slave station. More specifically, first, one of devices to communicate with each other issues device search information and searches for a device to be connected in the WFD mode. After the other device serving as a communication partner is found, the devices confirm information about services and functions that can be supplied by the respective devices. Note that the device supply information confirmation is an option and is not mandatory. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the information processing apparatus 101) among devices (for example, the information processing apparatus 101 and the communication apparatus 151) to communicate with each other serves as a client that plays a role of requesting various services. The other device implements the function of an access point in Wi-Fi by software setting. The software AP corresponds to a Wi-Fi master station, and the client corresponds to a Wi-Fi slave station. In the software AP mode, the client searches for a device serving as a software AP by device search information. After the software AP is found, the client and the software AP perform remaining wireless connection processing (establishment of wireless connection and the like) and then IP connection processing (assignment of an IP address and the like). Note that commands and parameters transmitted/received when implementing wireless connection between the client and the software AP may be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station and can thus decide a specific frequency band and channel to be used for communication in the direct connection mode. In this embodiment, the communication apparatus 151 can use a channel corresponding to the 2.4-GHz frequency band and a channel corresponding to the 5-GHz frequency band for communication in the direct connection mode. Then, the user can arbitrarily set a specific frequency band to be used (or a channel in a specific frequency band to be used) by making a setting on a screen displayed by the communication apparatus 151. In this embodiment, however, even if 5 GHz is selected on the screen displayed by the communication apparatus 151, the communication apparatus 151 does not use a channel corresponding to the Dynamic Frequency Selection (DFS) band in the 5-GHz frequency band for communication in the direct connection mode. In other words, the communication apparatus 151 uses only a channel corresponding to a frequency band other than the DFS band in the 5-GHz frequency band for communication in the direct connection mode. Note that if a radar wave in the frequency band corresponding to the channel is detected in a state in which a channel corresponding to the DFS band is used, the channel currently used needs to be changed. The frequency band in which the channel can be changed by detecting a radar wave is called the DFS band. Note that if, for example, a radio chip corresponding to a DFS function is used, it may be possible to use a channel corresponding to the Dynamic Frequency Selection (DFS) band in the 5-GHz frequency band for communication in the direct connection mode.

### Infrastructure Connection Method

Infrastructure connection is a connection form in which devices (for example, the information processing apparatus 101 and the communication apparatus 151) to communicate with each other are connected to an access point (for example, the access point 131) that controls a network of the devices, and the devices communicate with each other via the access point. As one connection mode, the communication apparatus 151 can operate in a mode (infrastructure connection mode) for communication by infrastructure connection.

In infrastructure connection, each device searches for an access point by device search information. After an access point is found, the device and the access point perform remaining wireless connection processing (establishment of wireless connection and the like) and then IP connection processing (assignment of an IP address and the like). Note that commands and parameters transmitted/received when implementing wireless connection between the device and the access point may be those defined by the Wi-Fi standard, and a description thereof will be omitted here.

In this embodiment, when the communication apparatus 151 operates in the infrastructure connection mode, the access point 131 operates as a master unit and the communication apparatus 151 operates as a slave unit. That is, in this embodiment, infrastructure connection means connection between the communication apparatus 151 operating as a slave unit and the apparatus operating as a master unit. In a case where the communication apparatus 151 establishes infrastructure connection and the information processing apparatus 101 also establishes infrastructure connection to the access point 131, the communication apparatus 151 and the information processing apparatus 101 can communicate with each other via the access point 131. Since the access point 131 decides a channel to be used for communication in infrastructure connection, the communication apparatus 151 executes communication in infrastructure connection using the channel decided by the access point 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection.

Note also that to communicate with the communication apparatus 151 via the access point 131, the information processing apparatus 101 needs to recognize that the communication apparatus 151 belongs to a network which is formed by the access point 131 and to which the information processing apparatus 101 belongs. Furthermore, in a case where the information processing apparatus 101 and the communication apparatus 151 are connected to the access point 131 by infrastructure connection, the communication apparatus 151 can be discovered by broadcast executed by the information processing apparatus 101.

However, in an environment where communication between the devices in a Local Area Network (LAN) is restricted, in the infrastructure connection method, the communication apparatus 151 returns no response to the broadcast executed by the information processing apparatus 101. Thus, the communication apparatus 151 cannot be discovered. Note that the environment where communication between the devices in the LAN is restricted is, for example, an environment where the access point to which the information processing apparatus 101 and the communication apparatus 151 are connected enables a privacy separator function. In this environment, since communication between the devices is restricted, the direct connection mode of the communication apparatus 151 may be disabled.

This embodiment can solve the problem arising in the above-described environment. More specifically, even in an environment where the information processing apparatus 101 cannot communicate with the communication apparatus 151 via the access point 131, it is possible to discover the communication apparatus 151 to perform communication. A detailed description will be provided below.

### Search Processing

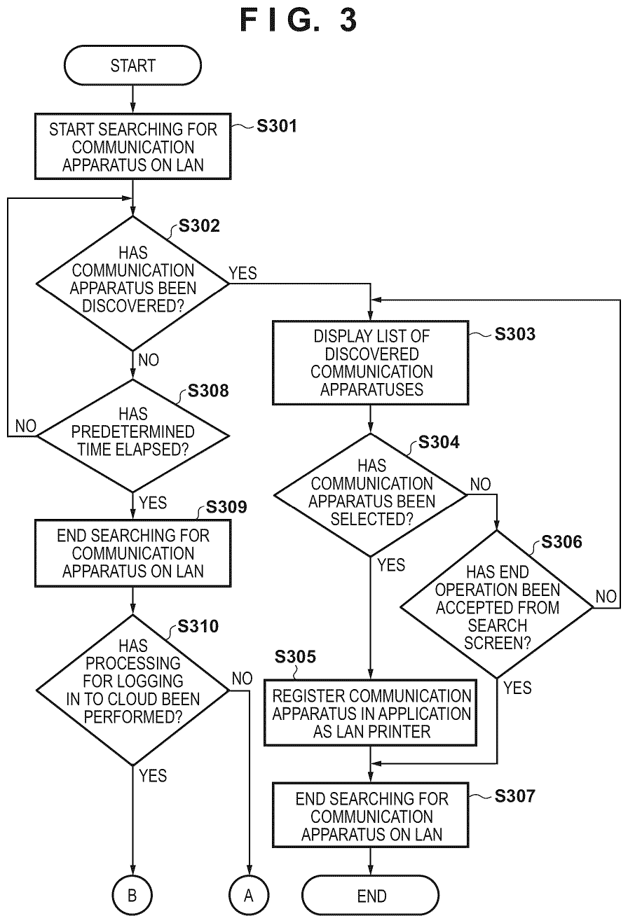

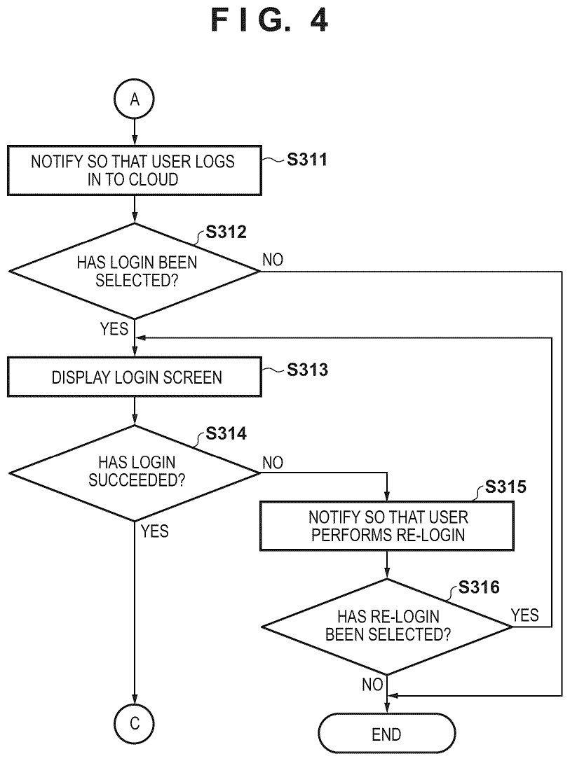

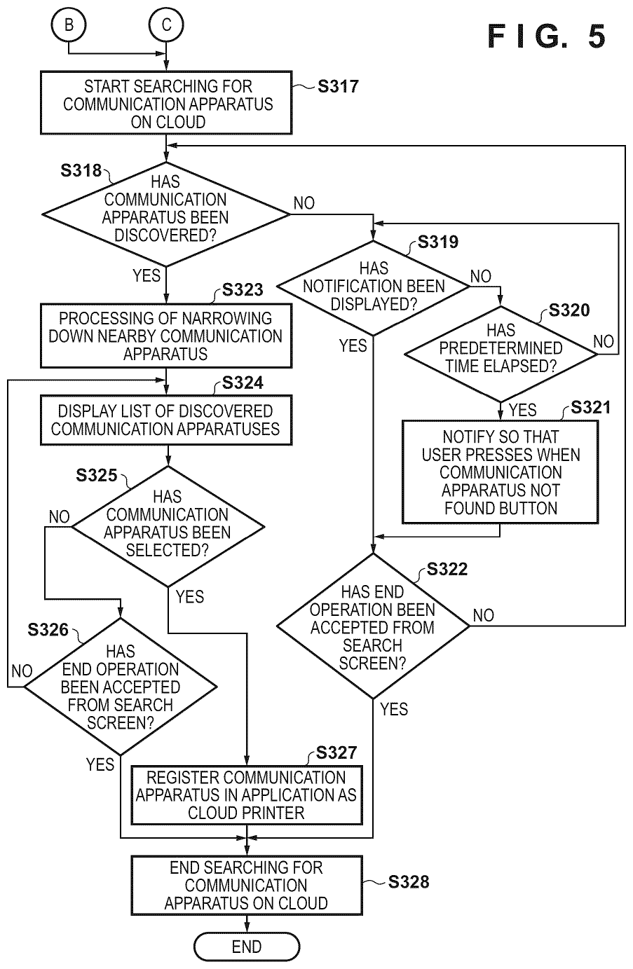

FIGS. 3, 4, and 5 show flowcharts illustrating an apparatus search processing by the communication application according to this embodiment. Note that each flowchart is implemented when the CPU 103 reads out various programs stored in the memory such as the external storage device 106 into the RAM 105 and executes them. More specifically, each flowchart is implemented by executing the communication application. This processing is started when the user performs an operation serving as a trigger for an apparatus search on a screen displayed by the communication application. Note that the present disclosure is not limited to this form and, for example, this processing may be started upon activation of the communication application.

In step S301, the CPU 103 searches for a communication apparatus 151 on the LAN to which the information processing apparatus 101 belongs. With this search, a communication apparatus 151 belonging to the LAN to which the information processing apparatus 101 belongs is discovered. More specifically, in this search, the CPU 103 searches for a communication apparatus 151 by instructing the OS to broadcast, as a packet, a signal for requesting a response from a communication apparatus 151 on the LAN to which the information processing apparatus 101 belongs. In other words, the LAN to which the information processing apparatus 101 belongs is a network formed by the access point 131 to which the information processing apparatus 101 is connected. Therefore, a communication apparatus 151 discovered by this search is a communication apparatus 151 connected to the access point 131 to which the information processing apparatus 101 is connected. Furthermore, in step S301, the CPU 103 instructs the OS to execute a search by WFD (that is, to transmit device search information by WFD) by executing an API for WFD. Thus, the CPU 103 executes transmission of the device search information by the OS. After that, the OS receives a device search response from a WFD-capable apparatus around the information processing apparatus 101. The CPU 103 acquires the device search response from the OS. This specifies, as an apparatus discovered by the search by WFD, the apparatus as the transmission source of the device search response. Note that among the apparatuses as the transmission sources of the device search responses, only the apparatus supporting the print service may be specified as an apparatus discovered by the search by WFD. It is possible to confirm which apparatus supports which service by communication between the information processing apparatus 101 and the apparatus as the transmission source of the device search response.

In step S302, the CPU 103 determines whether a response has been returned from a communication apparatus 151. In other words, it is determined whether a communication apparatus 151 has been discovered. If it is determined that the response has been returned, the CPU 103 displays, in step S303, a list of detected communication apparatuses 151 on a screen.

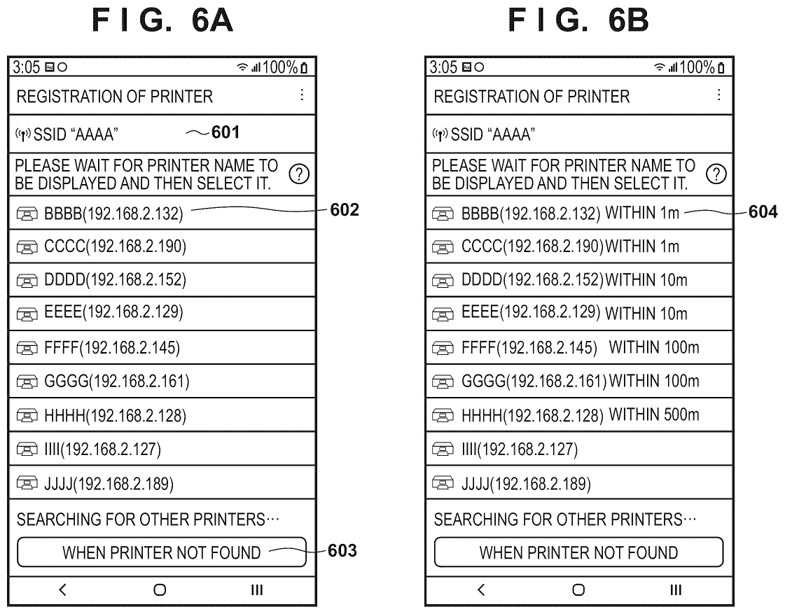

FIG. 6A shows an example of a list screen displayed in step S303. An SSID 601 is a connection destination SSID indicating the connection destination of the information processing apparatus 101. A list 602 is a list of discovered communication apparatuses 151. A button 603 is a button that is pressed when no printer is discovered. Note that a case where no printer is discovered includes not only a case where there is no discovered printer but also a case where there exists a discovered printer but a printer desired by the user is not discovered.

In step S304, the CPU 103 determines whether selection of a communication apparatus 151 has been accepted from the user on the screen. If it is determined that selection has been accepted, the CPU 103 registers, in step S305, the selected communication apparatus 151 in the communication application to be identifiable as a LAN printer. In other words, the LAN printer is an apparatus serving as a partner with which the information processing apparatus 101 communicates via the LAN to which the information processing apparatus 101 belongs. More specifically, the LAN to which the information processing apparatus 101 belongs is, for example, a network formed by the access point 131 to which the information processing apparatus 101 is connected in the infrastructure connection mode. More specifically, the LAN to which the information processing apparatus 101 belongs is, for example, a network formed by a communication apparatus 151 to which the information processing apparatus 101 is connected in the direct connection mode. In this embodiment, when the apparatus is discovered by the search by WFD, the apparatus serving as a partner of WFD communication is also included as a LAN printer. In step S307, the CPU 103 ends the search for a communication apparatus 151 on the network to which the information processing apparatus 101 belongs. Registration for making the communication apparatus 151 identifiable as a LAN printer will be described later.

If it is determined in step S304 that selection has not been accepted, the CPU 103 determines in step S306 whether a search end operation has been accepted. The search end operation is, for example, an operation of ending the search processing of FIGS. 3 to 5, and is, for example, acceptance of a return button or a “when printer not found” button. Note that if selection of the “when printer not found” button is accepted, it is possible to execute printer connection setting processing (setup). If it is determined that the search end operation has been accepted, the CPU 103 ends, in step S307, the search for a communication apparatus 151 on the network to which the information processing apparatus 101 belongs. If it is determined that the search end operation has not been accepted, the process returns to step S303.

If it is determined in step S302 that no communication apparatus 151 has been discovered, the CPU 103 determines in step S308 whether a predetermined time has elapsed since the start of the processing of step S301. The predetermined time may be an arbitrary time such as 10 sec. If it is determined that the predetermined time has not elapsed, the process returns to step S302. If it is determined that the predetermined time has elapsed, the CPU 103 ends, in step S309, the search for a communication apparatus 151 on the network to which the information processing apparatus 101 belongs.

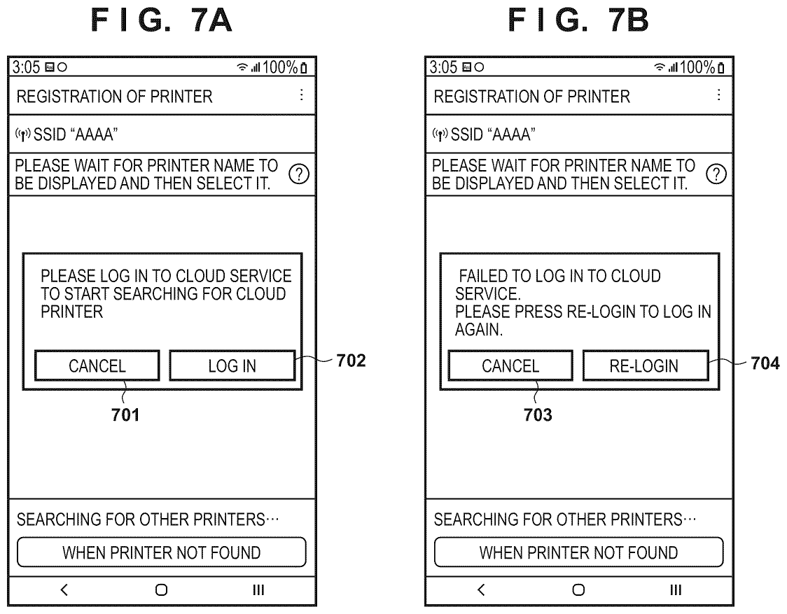

In step S310, the CPU 103 determines whether processing for logging in to the cloud server system 202 has been performed. As determination of whether the login processing has been performed, it is determined whether an access token has been stored in the external storage device 106. If it is determined that no access token has been stored, it is determined that the login processing has not been performed, and the CPU 103 displays, in step S311, on the screen, a notification screen for prompting the user to perform the processing for logging in to the cloud server system 202. The notification screen is, for example, a screen on which a message for prompting the user to perform processing for logging in to the cloud server system 202 is described, as shown in FIG. 7A, and on which a cancel button 701 and a login button 702 are provided in a lower portion. In step S312, the CPU 103 determines whether the login button has been selected on the notification screen. More specifically, for example, the CPU 103 determines which of the cancel button 701 and the login button 702 has been pressed. If it is determined that the cancel button 701 has been selected, the CPU 103 ends the display of the notification screen, and ends the processing of FIGS. 3 to 5. If it is determined that the login button 702 has been selected, the CPU 103 displays a login screen (not shown) of the cloud server system 202 in step S313. The login screen of the cloud server system 202 is, for example, a screen including a user ID input field, a tenant ID input field, and a password input field, and including a login button in a lower portion. If the user ID, tenant ID, and password input by the user match information of the authentication service 204 of the cloud server system 202, the login processing succeeds.

In step S314, the CPU 103 determines whether the login processing has succeeded. If it is determined that the login processing has succeeded, the CPU 103 ends the display of the login screen of the cloud server system 202, and stores an access token in the external storage device 106. If it is determined that the login processing has not succeeded, that is, the login processing has failed, the CPU 103 displays, in step S315, a notification screen for notifying the user so that the user performs the login processing again. The notification screen is, for example, a screen on which a message for prompting the user to perform the login processing again is described, as shown in FIG. 7B, and on which a cancel button 703 and a re-login button 704 are provided in a lower portion. In step S316, the CPU 103 determines whether the re-login button has been selected on the notification screen. More specifically, for example, the CPU 103 determines which of the cancel button 703 and the re-login button 704 has been pressed. If it is determined that the re-login button 704 has been selected, the process returns to step S313, and the CPU 103 displays the login screen of the cloud server system 202 again. If it is determined that the cancel button 703 has been selected, the CPU 103 ends the display of the notification screen, and ends the processing of FIGS. 3 to 5.

If it is determined in step S310 that the processing for logging in to the cloud server system 202 has been performed or it is determined in step S314 that the login processing has succeeded, the CPU 103 searches, in step S317, for a communication apparatus 151 that is registered in a cloud service to which the information processing apparatus 101 has logged in and which is provided by the cloud server system 202. More specifically, the CPU 103 communicates with the cloud server system 202 via the access point 131, and transmits the access token stored in the external storage device 106 to the cloud server system 202. Then, the cloud server system 202 specifies a user account corresponding to the received access token. After that, the cloud server system 202 specifies a tenant managed in linkage with the specified user account. Then, the cloud server system 202 searches for a communication apparatus 151 registered in linkage with the specified tenant and registered in the cloud service, and transmits information of a communication apparatus 151 discovered by the search to the information processing apparatus 101. Note that the information processing apparatus 101 may transmit information corresponding to the tenant to the cloud server system 202 instead of the access token. The cloud server system 202 may specify the tenant based on the information.

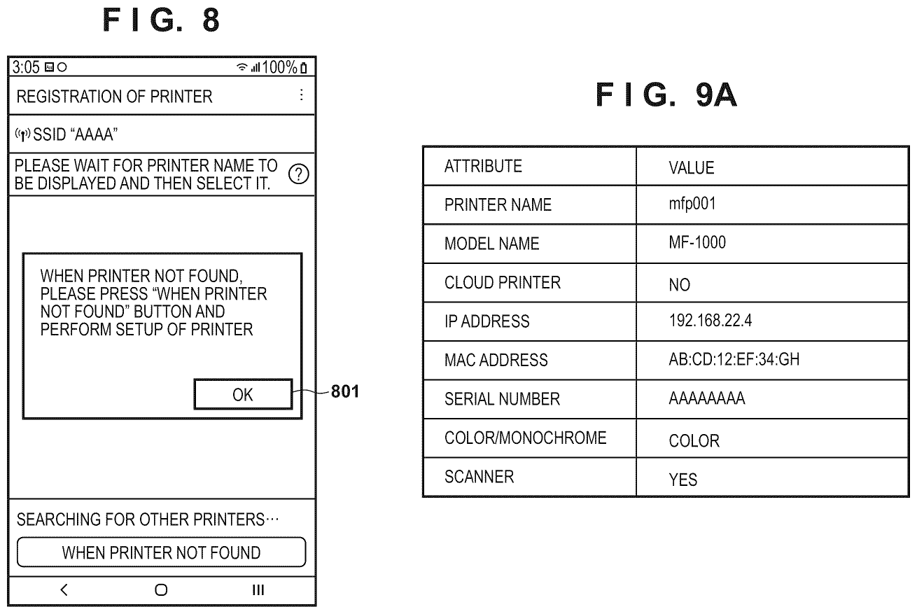

In step S318, the CPU 103 determines whether the information of the communication apparatus 151 has been received from the cloud server system 202. In other words, the CPU 103 determines whether a communication apparatus 151 of the cloud server system 202 has been discovered. If it is determined that the information of a communication apparatus 151 has not been received, the CPU 103 determines in step S319 whether the notification has been displayed. Display of the notification is, for example, display of a notification screen shown in FIG. 8. If it is determined that the notification has not been displayed, the CPU 103 determines in step S320 whether a predetermined time has elapsed since the start of the processing of step S317. The predetermined time may be an arbitrary time such as 10 sec. If it is determined that the predetermined time has elapsed, the CPU 103 displays, in step S321, for example, the notification screen shown in FIG. 8. The notification screen shown in FIG. 8 is merely an example, and is a screen for notifying that no printer has been discovered and a corresponding method in this case. On the other hand, if it is determined that the predetermined time has not elapsed, the processing from step S319 is repeated. If it is determined in step S319 that the notification has been displayed, or the pressing of an OK button 801 has been accepted, the CPU 103 determines in step S322 whether a search end operation has been accepted. If it is determined that the search end operation has been accepted, the CPU 103 ends, in step S328, the communication with the cloud server system 202, thereby ending the search for the cloud printer. On the other hand, if it is determined that the search end operation has not been accepted, the processing from step S318 is repeated.

If it is determined in step S318 that the information of a communication apparatus 151 has been received from the cloud server system 202, the CPU 103 executes, in step S323, processing of narrowing down nearby printers. As the processing in step S323, for example, the radio field intensity of the direct connection access point of the communication apparatus 151 and the radio field intensity of Bluetooth communication between the short distance wireless communication unit 110 and the short distance wireless communication unit 157 are acquired. Beacon transmission such as SSID broadcast of the communication unit 156 and advertising of the short distance wireless communication unit 157 may always be performed to acquire the radio field intensity in step S323, or beacon transmission may be started after receiving, from the cloud server system 202, an instruction to transmit a beacon for a predetermined time. For example, at the start of the cloud printer search in step S317, when the CPU 103 communicates with the cloud server system 202, the cloud server system 202 may instruct the communication apparatus 151 to transmit a beacon for a predetermined time. For example, the information processing apparatus 101 identifies the communication apparatus 151 based on information of the beacon received from the short distance wireless communication unit 157, and links, as distance information, a result of measuring a distance between the information processing apparatus 101 and the communication apparatus 151 with the information of the communication apparatus 151 received in step S317. Note that the processing in step S323 may be omitted. That is, a form in which nearby printers are not narrowed down may be possible.

In step S324, the CPU 103 displays the list screen showing the list of communication apparatuses 151 corresponding to the information received from the cloud server system 202. This screen is a list screen showing a list of one or a plurality of communication apparatuses 151 which have been discovered by the cloud server system 202 because they are registered in the cloud service and which correspond to the access token transmitted from the information processing apparatus 101. Then, on this screen, distance information linked with the information of each communication apparatus 151 is shown. FIG. 6B shows an example of the list screen displayed in step S324. Distance information 604 indicates distance information from the information processing apparatus 101, and is, for example, controlled to be displayed at a higher position as the distance is closer. The distance information may be the distance between the information processing apparatus 101 and the communication apparatus 151, which is calculated from the radio field intensity, or thresholds may be provided for the radio field intensity and a short distance, a middle distance, a long distance, or the like may be displayed for each threshold. For example, if the radio field intensity is equal to or higher than −50 dbm, a short distance is displayed, if the radio field intensity falls within the range of −70 dbm (inclusive) to −50 dbm (exclusive), a middle distance is displayed, and if the radio field intensity falls within the range of −80 dbm (inclusive) to −70 dbm (exclusive), a long distance is displayed. The apparatus whose distance information indicates a long distance need not be displayed on the screen, or the distance information need not be displayed. A form in which the distance information 604 is not displayed on the list screen regardless of the distance indicated by the distance information may be possible. Even in a form in which the processing in step S323 is omitted, the distance information 604 is not displayed on the list screen.

In step S325, the CPU 103 determines whether a communication apparatus 151 displayed on the screen in step S324 has been selected. If it is determined that a communication apparatus 151 has been selected on the screen, the CPU 103 registers, in step S327, the selected communication apparatus 151 in the communication application to be identifiable as a cloud printer. Registration information for making it possible to identify the communication apparatus 151 as a cloud printer will be described later. On the other hand, if it is determined that a communication apparatus 151 has not been selected on the screen, the CPU 103 determines in step S326 whether a search end operation has been accepted. If it is determined that the search end operation has not been accepted, the processing from step S324 is repeated. After the completion of the registration in step S327, or it is determined in step S326 that the search end operation has been accepted, the CPU 103 ends the communication with the cloud server system 202 in step S328, thereby ending the cloud printer search.

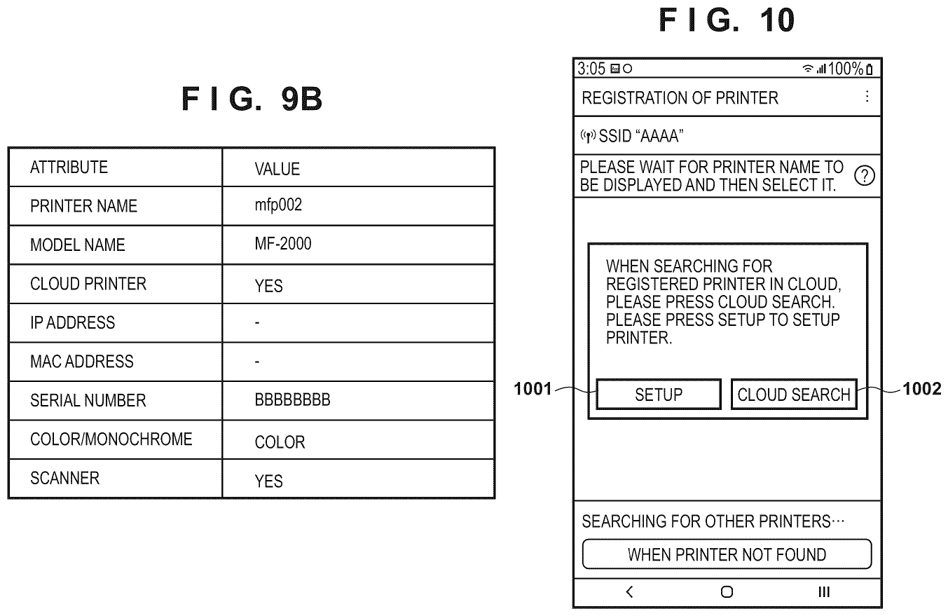

Registration information of the communication apparatus 151 in the communication application will be described. FIGS. 9A and 9B are tables each showing an example of the registration information in the communication application. In step S305, for example, the CPU 103 registers the registration information shown in FIG. 9A in the communication application to be able to identify the communication apparatus 151 as a LAN printer. In step S327, for example, the CPU 103 registers the registration information shown in FIG. 9B in the communication application to be able to identify the communication apparatus 151 as a cloud printer. The cloud printer indicates the communication apparatus registered, in the communication application, as a printer that is used by the user (performs communication) via the cloud server system 202. As shown in FIG. 9A, data representing the registration information is formed as a data set including attributes and values. The attributes are, for example, items including a printer name, a model name, information of whether the communication apparatus is a cloud printer, an IP address, a MAC address, a serial number, color/monochrome, and the presence/absence of a scanner, and the values are pieces of detailed information corresponding to the items. As shown in FIG. 9A, in step S305, information indicating that the communication apparatus is not a cloud printer, such as “NO”, is stored in the item of the information of whether the communication apparatus is a cloud printer. On the other hand, as shown in FIG. 9B, in step S327, registration information indicating that the communication apparatus is a cloud printer, such as “YES”, is stored in the item of the information of whether the communication apparatus is a cloud printer.

The printer search method is not limited to the processing shown in FIGS. 3 to 5. For example, even in a case where the printer is discovered by the search for the LAN printer, the cloud printer search may further be executed without displaying the search result screen, and the printers discovered by the search operations may collectively be displayed as a search result screen.

The processing (steps S301 to S307) for the LAN printer search and the processing (steps S317 to S328) for the cloud printer search may be executed in a reverse order or in parallel. After the end of each search, instead of displaying the search result screen, the discovered apparatus may additionally be displayed on the search result screen every time the apparatus is discovered by each search.

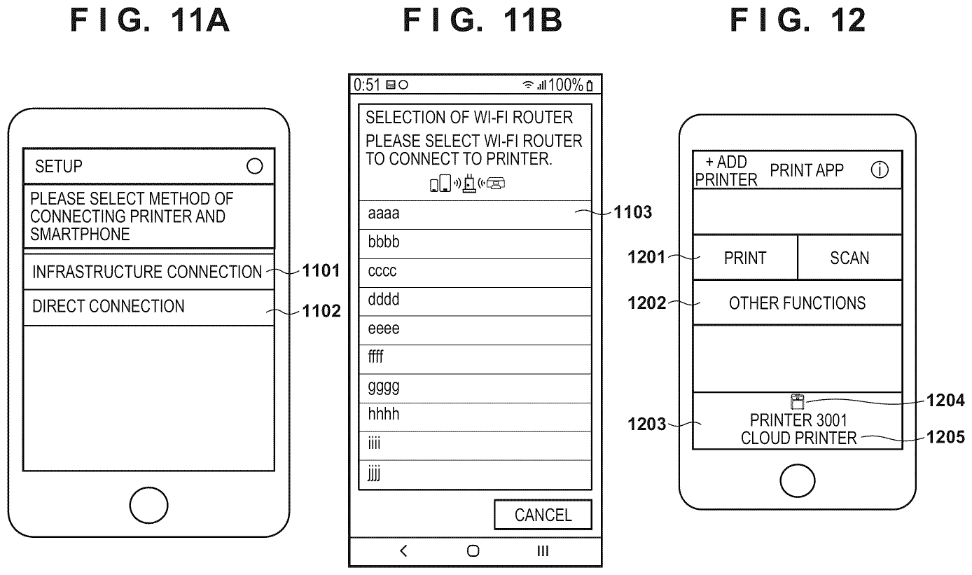

A method of shifting to the cloud printer search is not limited to the processing shown in FIGS. 3 to 5. For example, when the “when printer not found” button 603 shown in FIG. 6A is pressed, a notification screen shown in FIG. 10 is displayed. On this notification screen, the user is prompted to confirm whether to perform a cloud printer search or setup. When selection of a cloud printer search button 1002 is accepted, the CPU 103 ends the display of the notification screen shown FIG. 10 and starts a cloud printer search. If selection of a setup button 1001 is accepted, the CPU 103 displays a setup selection screen shown in FIG. 11A. On this selection screen, the communication application can perform connection setting processing of the communication apparatus 151. To perform connection setting processing, the communication apparatus 151 needs to have shifted to the connection setting mode, and a trigger for the communication apparatus 151 to start an operation in the connection setting mode is, for example, the pressing of a connection setting mode button by the user. The connection setting mode button may be a hardware (physical) button provided in the communication apparatus 151 or a software button displayed on the operation display unit 160 by the communication apparatus 151. When the communication apparatus 151 starts an operation in the connection setting mode, the communication apparatus 151 enables the access point (connection setting access point) dedicated for the connection setting mode in the communication apparatus 151. This allows the communication apparatus 151 to establish Wi-Fi Direct connection to the information processing apparatus 101. Connection information (Service Set Identifier (SSID) and password) for connection to the connection setting access point is held in advance in the communication application. Therefore, the CPU 103 recognizes in advance the connection information for connection to the connection setting access point.

On the setup selection screen, an infrastructure connection button 1101 and a direct connection button 1102 are displayed. If selection of the infrastructure connection button 1101 is accepted, the CPU 103 prompts the user to select the access point 131 for connection between the information processing apparatus 101 and the communication apparatus 151 on a Wi-Fi access point selection screen shown in FIG. 11B. If selection of an access point button 1103 is accepted, the CPU 103 prompts the user to input the password of the access point 131, thereby acquiring connection information. The CPU 103 transmits the acquired connection information (SSID and password) to the communication apparatus 151, and connects the communication apparatus 151 to the access point 131. In addition, the CPU 103 acquires cloud registration information from the communication apparatus 151 via direct connection in the connection setting mode. The cloud registration information includes information necessary to register the communication apparatus 151 in the cloud server system 202, and specifically includes, for example identification information of the communication apparatus 151, license information for registration in the cloud server system 202, and device group registration information. The identification information of the communication apparatus 151 specifically includes, for example, the serial number, the model name, and the like of the communication apparatus 151. The device group registration information specifically includes, for example, information indicating a tenant to be linked with the communication apparatus 151. The MAC address of the communication apparatus 151 may be included. Note that the cloud registration information may be acquired before the connection information to the access point 131 is transmitted to the communication apparatus 151.

The CPU 103 switches the connection of the communication unit 109 from the communication unit 156 operating as the connection setting access point to the access point 131 using the above-described connection information. Then, the CPU 103 searches for a communication apparatus 151 via the access point 131 (via infrastructure connection). The CPU 103 determines whether a communication apparatus 151 that has performed connection setting processing has been discovered. If it is determined that a communication apparatus 151 has been discovered, the communication apparatus 151 is registered in the communication application to be identifiable as a LAN printer. If it is determined that no communication apparatus 151 has been discovered, the CPU 103 transmits the cloud registration information to the cloud server system 202, and executes registration processing of the communication apparatus 151 in the cloud service. Upon receiving the cloud registration information, the cloud server system 202 manages, in linkage with each other, the tenant indicated by the device group registration information included in the cloud registration information and the communication apparatus 151 indicated by identification information included in the cloud registration information. This registers the communication apparatus 151 in the cloud service provided by the cloud server system 202. Note that for example, if the cloud registration information transmitted to the cloud server system 202 by the CPU 103 in this processing matches the cloud registration information transmitted to the cloud server system 202 by the communication apparatus 151 upon completion of the connection setting processing, it may be determined that the registration processing of the communication apparatus 151 in the cloud service succeeds. If the model of the communication apparatus 151 is a registration target model, it may be determined that the registration processing of the communication apparatus 151 in the cloud service succeeds. Note that the present disclosure is not limited to these forms, and if the cloud server system 202 attempts to access the communication apparatus 151 using the cloud registration information transmitted to the cloud server system 202 by the information processing apparatus 101 and the access succeeds, it may be determined that the registration processing of the communication apparatus 151 in the cloud service succeeds. If the registration processing of the communication apparatus 151 in the cloud service succeeds, the cloud server system 202 transmits a response indicating registration success to the information processing apparatus 101. If the registration processing of the communication apparatus 151 in the cloud service fails, the cloud server system 202 transmits a response indicating a registration failure to the information processing apparatus 101. A case where the registration processing fails is, for example, a case where the cloud registration information transmitted to the cloud server system 202 by the information processing apparatus 101 does not match the cloud registration information transmitted to the cloud server system 202 by the communication apparatus 151 upon completion of the connection setting processing. There is also a case where the model of the communication apparatus 151 is a model other than the registration target.

The CPU 103 determines, based on the response from the cloud server system 202, whether the above-described registration processing succeeds or fails. If it is determined that the registration processing succeeds, the CPU 103 registers the communication apparatus 151 in the communication application to be identifiable as a cloud printer. If it is determined that the registration processing fails, the CPU 103 notifies that the registration of the communication apparatus 151 in the cloud service fails

If the pressing of the direct connection button 1102 is accepted, the CPU 103 transmits, to the communication apparatus 151, a command to set the direct connection mode. Upon receiving the command to set the direct connection mode from the CPU 103, the communication apparatus 151 transmits the direct connection SSID to the information processing apparatus 101, and changes the connection mode of the communication apparatus 151 from the connection setting mode to the direct connection mode. The direct connection SSID is the SSID of the access point, different from the connection setting access point, in the communication apparatus 151, and the SSID used to perform direct connection to the information processing apparatus 101. Note that at this time, the communication apparatus 151 disables the connection setting access point by canceling the connection setting mode. After that, the communication apparatus 151 operates to be able to perform direct connection to the information processing apparatus 101 by enabling the access point having the direct connection SSID. Furthermore, at this time, the CPU 103 performs direct connection to the communication apparatus 151 by setting the connection destination SSID as the direct connection SSID. With this configuration, after setting the communication apparatus 151 in the direct connection mode, the information processing apparatus 101 can perform direct connection to the communication apparatus 151. Then, the communication apparatus 151 is registered in the communication application to be identifiable as a LAN printer.

As described above, according to this embodiment, the CPU 103 searches, via the access point 131, for a communication apparatus 151 on the network to which the information processing apparatus 101 belongs. If a communication apparatus 151 is discovered, a communication apparatus 151 selected from the search result by the user is registered in the communication application to be identifiable as a LAN printer. If there is no response from a communication apparatus 151 even after the lapse of the predetermined time, the CPU 103 searches for a communication apparatus 151 on the cloud server system 202 via the access point 131. If a communication apparatus 151 is discovered, a communication apparatus 151 selected from the search result by the user is registered in the communication application to be identifiable as a cloud printer.

Thus, even in a case where a setting is made to disable communication by infrastructure connection between the information processing apparatus 101 and the communication apparatus 151, the communication apparatus 151 can be used as a cloud printer. When the registration information shown in FIG. 9B is registered in the communication setting application, the communication apparatus is displayed on the screen of the communication application to be identifiable as a cloud printer. FIG. 12 shows an example of the home screen of the communication application after the connection setting processing is performed. On the screen shown in FIG. 12, printer information 1203 indicating a communication apparatus 151 registered in the communication application in step S327 is displayed. The printer information 1203 includes an icon 1204 corresponding to the model of the communication apparatus 151 and text 1205 indicating that the communication apparatus 151 is a cloud printer, and the communication apparatus 151 is displayed to be identifiable as a cloud printer. Note that if the communication apparatus 151 registered in the communication application is a LAN printer, the printer information 1203 includes the icon 1204 corresponding to the model of the communication apparatus 151 and text indicating that the communication apparatus 151 is a LAN printer. However, the present disclosure is not limited to this form. If the communication apparatus 151 registered in the communication application is a LAN printer, the printer information 1203 need not include text indicating that the communication apparatus 151 is a LAN printer. Even if the communication apparatus 151 registered in the communication application is a cloud printer, the printer information 1203 need not include the text 1205. Furthermore, the timing of executing the registration processing of the communication apparatus 151 in the cloud service and the detailed contents of the processing for registering the communication apparatus 151 in the cloud service are not limited to the above-described form. For example, the registration processing of the communication apparatus 151 in the cloud service may be executed at an arbitrary timing other than a timing after the connection setting processing is executed. More specifically, for example, by providing, on the screen of the communication application, a button for executing the registration processing of the communication apparatus 151 in the cloud service, the registration processing may be started at a timing of pressing the button. Alternatively, the registration processing may be executed without intervention of communication between the information processing apparatus 101 and the communication apparatus 151. More specifically, for example, when an operation for the registration processing is performed on the communication apparatus 151, the communication apparatus 151 may transmit the cloud registration information to the cloud server system 202 without intervention of communication between the information processing apparatus 101 and the communication apparatus 151.

### Print Processing by Printer

Processing in which the communication application of the information processing apparatus 101 instructs the communication apparatus 151 to execute printing will be described next.

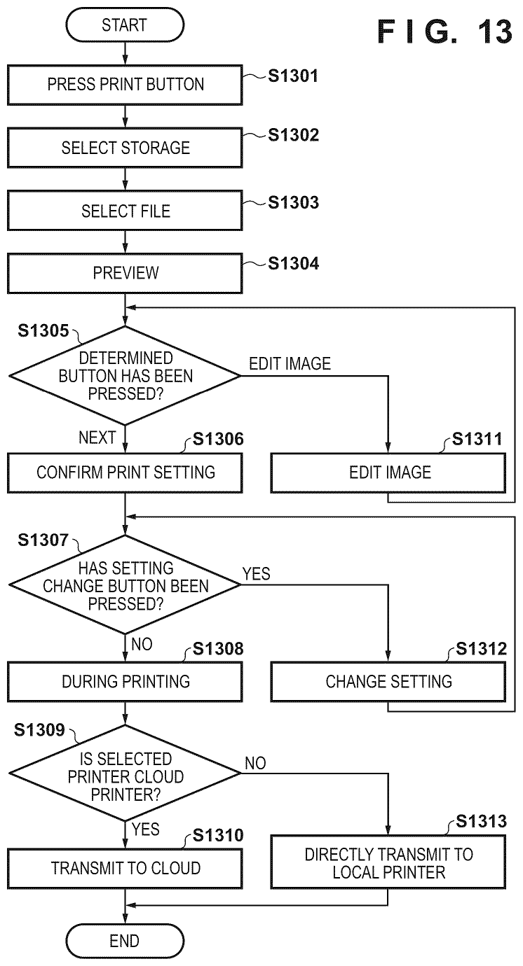

FIG. 13 is a flowchart illustrating processing in which the communication application of the information processing apparatus 101 instructs the communication apparatus 151 to execute printing. The processing shown in FIG. 13 is implemented when, for example, the CPU 103 of the information processing apparatus 101 reads out a program, such as the communication application, stored in the ROM 104 into the RAM 105 and executes it. The processing shown in FIG. 13 is performed after registration of the communication apparatus 151 in the communication application in the processing shown in FIGS. 3 to 5. Then, the user selects one of the communication apparatuses 151 registered in the communication application. The processing shown in FIG. 13 is performed in a state in which the currently selected communication apparatus 151 is specified.

In step S1301, the CPU 103 accepts a print start instruction from the user. More specifically, for example, the pressing of a button 1201 indicating “print” is accepted on the screen shown in FIG. 12.

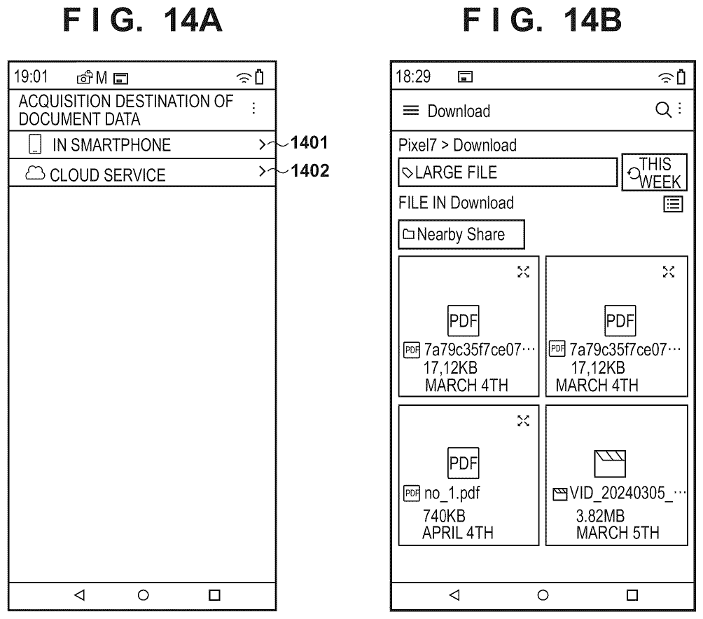

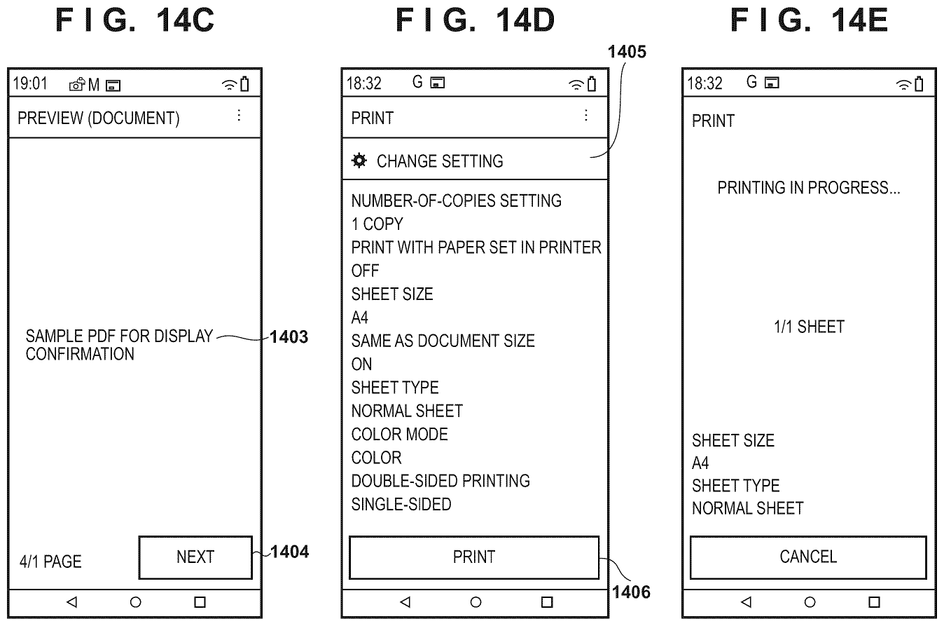

In step S1302, the CPU 103 accepts selection of a method of acquiring a print target file from the user. In other words, selection of a storage as the acquisition source of a print target file is accepted. More specifically, for example, the CPU 103 displays a screen shown in FIG. 14A. To acquire a print target file from the external storage device 106 in the information processing apparatus 101, the user presses a button 1401 indicating “smartphone”. To acquire a print target file from the cloud storage on the cloud server system 202, the user presses a button 1402 indicating “cloud service”.

In step S1303, the CPU 103 accepts selection of the print target file from the user. More specifically, for example, the CPU 103 displays a screen shown in FIG. 14B on the operation display unit 108. If selection is made on a file selection screen (not shown) from the cloud storage, the selected file is temporarily downloaded from the cloud storage to a primary area of the external storage device 106 of the information processing apparatus 101.

In step S1304, the CPU 103 displays a preview of the file selected in step S1303. More specifically, for example, a screen shown in FIG. 14C is displayed. A preview image 1403 and a “next” button 1404 are displayed on the screen shown in FIG. 14C. Although not shown in FIG. 14C, an editing button for editing the file of the preview image 1403 may be displayed. This embodiment assumes that the editing button is displayed.

In step S1305, the CPU 103 determines the button which has been pressed on the screen displayed in step S1304. If it is determined that the editing button has been pressed, the CPU 103 displays, in step S1311, on the operation display unit 108, an editing screen (not shown) for editing the file of the preview image 1403. On the editing screen, an image editing function of, for example, trimming the image or performing sepia conversion can be executed. After step S1311, the processing from step S1305 is repeated. If it is determined in step S1305 that the “next” button 1404 has been pressed, the process advances to step S1306.

In step S1306, the CPU 103 displays a screen for prompting the user to confirm print settings. More specifically, for example, a screen shown in FIG. 14D is displayed. A button 1406 for accepting an instruction to execute printing and a button 1405 for changing the print settings are displayed on the screen shown in FIG. 14D.

In step S1307, the CPU 103 determines the button which has been pressed on the screen displayed in step S1306. If it is determined that the button for changing the print settings has been pressed, the CPU 103 displays, in step S1312, a screen (not shown) for changing the print settings. The user can change the print settings on the screen. After step S1312, the processing from step S1307 is repeated. If it is determined in step S1307 that the button for accepting the instruction to execute printing has been pressed, the process advances to step S1308.

In step S1308, the CPU 103 displays a screen indicating that printing is in progress. More specifically, for example, a screen shown in FIG. 14E is displayed on the operation display unit 108. Note that actual print processing is started after step S1309 of the succeeding stage.

In step S1309, the CPU 103 determines whether the communication apparatus 151 that executes printing is a cloud printer (or a LAN printer). That is, the CPU 103 determines whether the currently selected communication apparatus 151 is registered as a printer with which communication is performed via the cloud server system 202 or a printer with which communication is performed via the access point 131 without going through of the cloud server system 202. Then, if the CPU 103 determines that the communication apparatus 151 that executes printing is a cloud printer, the process advances to step S1310. On the other hand, if the CPU 103 determines that the communication apparatus 151 that executes printing is not a cloud printer (is a LAN printer), the process advances to step S1313. More specifically, for example, if detailed information of the item of “whether the communication apparatus is a cloud printer” of the registration information shown in FIG. 9A or 9B indicates that it is a cloud printer, the process advances to step S1310. On the other hand, if the detailed information indicates that it is not a cloud printer, the process advances to step S1313.

In step S1310, the CPU 103 transmits, to the cloud server system 202 via the access point 131, the file selected in step S1303, the print setting information, the access token stored in the external storage device 106, and the registration information of the communication apparatus 151 shown in FIG. 9B. At this time, if the access token is not stored in the external storage device 106, the login processing (steps S311 to S316) is performed. In this case, if it is determined in step S314 that the login processing has succeeded, the access token is stored in the external storage device 106, and the processing in step S1310 is performed.

That is, if the communication apparatus 151 is registered as the cloud printer in the communication application, the print processing by the communication apparatus 151 is executed as cloud printing. This transmits, from the cloud server system 202 to the communication apparatus 151, the file selected in step S1303 and the print job for causing the communication apparatus 151 to execute printing based on the print setting information. Then, in accordance with the print job, the communication apparatus 151 executes printing based on the file selected in step S1303 and the print setting information. After step S1310, the processing shown in FIG. 13 ends.

In step S1313, the CPU 103 transmits, to the communication apparatus 151 via the access point 131, the file selected in step S1303, the print setting information, and a print instruction. This transmits the file selected in step S1303 and the print job for causing the communication apparatus 151 to execute printing based on the print setting information to the communication apparatus 151 via the access point 131 without intervention of the cloud server system 202. Then, in accordance with the print job, the communication apparatus 151 executes printing based on the file selected in step S1303 and the print setting information. That is, if the communication apparatus 151 is not registered as a cloud printer in the communication application, the information processing apparatus 101 sends a print instruction to the communication apparatus 151 via infrastructure connection.

As described above, according to this embodiment, even in a case where the information processing apparatus 101 cannot instruct printing since the information processing apparatus 101 and the communication apparatus 151 cannot communicate with each other via the access point 131, printing by the communication apparatus 151 can be executed as cloud printing.

The print target file transmitted to the cloud server system 202 in step S1310 or transmitted to the communication apparatus 151 in step S1313 may be a selected image file of the PDF or JPEG format, or a print format. The print format is, for example, a RAW image format or a Print Description Language (PDL) format interpretable by the printer.

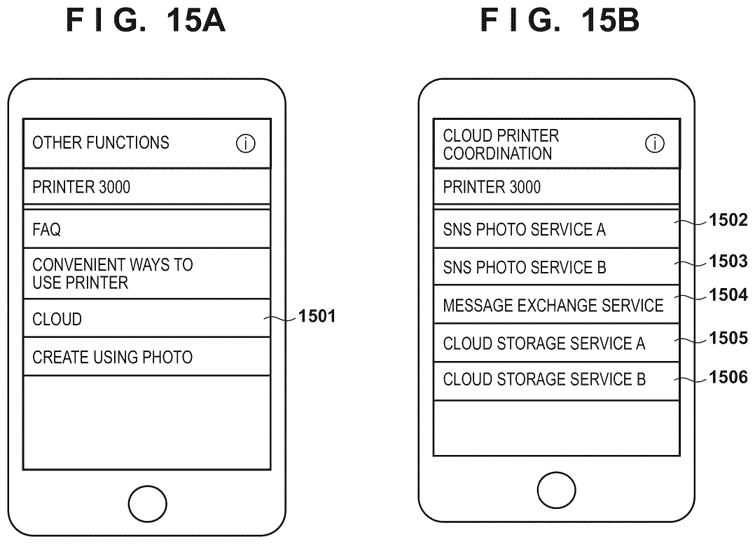

When the pressing of an “other functions” button 1202 on the screen shown in FIG. 12 is accepted, the CPU 103 displays a screen indicating a list of other functions, as shown in FIG. 15A. When the pressing of a “cloud” button 1501 is accepted on the screen shown in FIG. 15A, the CPU 103 displays a screen indicating a list of cloud cooperation functions, as shown in FIG. 15B. At this time, the CPU 103 communicates with the cloud server system 202, and performs user authentication. More specifically, the CPU 103 acquires the access token corresponding to the login user from the external storage device 106, and transmits the access token to the cloud server system 202, thereby performing user authentication. At this time, if the access token is not stored, the login processing (steps S311 to S316) is performed. If it is determined in step S314 that the login processing has succeeded, the CPU 103 stores the access token in the external storage device 106, and communicates with the cloud server system 202, thereby performing user authentication.

On the screen shown in FIG. 15B, cloud storage service buttons 1505 and 1506 for executing printing based on data in the cloud storage are selectable. Photo service buttons 1502 and 1503 for executing printing based on photo data on the Internet are selectable. In addition, a message exchange service button 1504 for printing one printed product by combining a message and photo data on the Internet is selectable.

In a print function implemented by the cloud storage service button 1505 or 1506 shown in FIG. 15B, the cloud server system 202 acquires data from the cloud storage service 205, and directly transmits the acquired data to the communication apparatus 151. On the other hand, in a print function implemented by the cloud service button 1402 shown in FIG. 14A, data in the cloud storage is temporarily downloaded to the information processing apparatus 101, and transmitted to the cloud server system 202 again. Therefore, the user can execute printing after executing, for the data in the cloud storage, the image editing function of the print function of the communication application, for example, the image editing function of trimming an image or performing sepia conversion. In this embodiment, since the two kinds of interfaces including the cloud service button 1402 and the cloud storage service buttons 1505 and 1506 are provided, the user can edit, in the information processing apparatus 101, the data in the cloud storage at an arbitrary timing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-229382, filed Dec. 25, 2024 which is hereby incorporated by reference herein in its entirety.

What is claimed is:

1. A control method for an information processing apparatus, comprising:
executing first search processing as processing of searching for a communication apparatus belonging to a network formed by an access point to which the information processing apparatus is connected;
executing, based on a fact that no communication apparatus is discovered by the first search processing, second search processing as processing of searching for a registered communication apparatus in a predetermined cloud server system capable of communicating via the Internet; and
executing, via communication with the predetermined cloud server system, communication with a communication apparatus discovered by the second search processing.

2. The method according to claim 1, further comprising:
executing, in a case where the communication apparatus is discovered by the first search processing, via the network formed by the access point, communication with the communication apparatus discovered by the first search processing.

3. The method according to claim 2, wherein the communication with the communication apparatus discovered by the first search processing is executed without intervention of the communication with the predetermined cloud server system.

4. The method according to claim 1, wherein
in the second search processing, information concerning a predetermined user account is transmitted to the predetermined cloud server system, and
in a case where the information concerning the predetermined user account is transmitted to the predetermined cloud server system, the communication apparatus corresponding to the predetermined user account and registered in the predetermined cloud server system is discovered.

5. The method according to claim 4, further comprising:
displaying, based on the fact that no communication apparatus is discovered by the first search processing, a screen for acquiring the information concerning the predetermined user account.

6. The method according to claim 5, wherein
the screen is a screen for accepting, from a user, an input of login information for logging in to the predetermined cloud server system, and
the information concerning the predetermined user account is an access token that is provided from the predetermined cloud server system at a time of logging in to the predetermined cloud server system by the login information.

7. The method according to claim 1, further comprising:
displaying a list screen including a list of communication apparatus discovered by the first search processing,
wherein the list screen includes a button corresponding to the fact that no communication apparatus is discovered by the first search processing, and
even in a case where any communication apparatus is discovered by the first search processing, the second search processing is executed based on an operation of the button.

8. The method according to claim 1, wherein the first search processing includes processing of instructing an operating system of the information processing apparatus to broadcast a packet for requesting a response from the communication apparatus.

9. The method according to claim 1, further comprising:
executing third search processing as processing of searching for the communication apparatus complying with a standard for performing communication without intervention of the access point,
wherein the second search processing is executed based on a fact that no communication apparatus is discovered by either the first search processing or the third search processing.

10. The method according to claim 9, wherein the standard is Wi-Fi Direct®.

11. The method according to claim 1, further comprising:
registering the communication apparatus discovered by the first search processing in a predetermined application program of the information processing apparatus; and
registering the communication apparatus discovered by the second search processing in the predetermined application program.

12. The method according to claim 11, wherein an item included in information for registering the communication apparatus discovered by the first search processing in the predetermined application program is different from an item included in information for registering the communication apparatus discovered by the second search processing in the predetermined application program.

13. The method according to claim 12, wherein the information for registering the communication apparatus discovered by the first search processing in the predetermined application program includes items of an IP address and a MAC address, and the information for registering the communication apparatus discovered by the second search processing in the predetermined application program includes no items of an IP address and a MAC address.

14. The method according to claim 13, further comprising:
displaying a screen including information concerning the communication apparatus registered in the predetermined application program,
wherein in a case where the communication apparatus registered in the predetermined application program is the communication apparatus discovered by the second search processing, information indicating that the communication apparatus registered in the predetermined application program is the communication apparatus discovered by the second search processing is displayed on the screen.

15. The method according to claim 1, wherein the communication with the communication apparatus discovered by the second search processing includes processing of transmitting, to the communication apparatus, a print job for causing the communication apparatus to execute printing.

16. The method according to claim 1, wherein a case where no communication apparatus is discovered by the first search processing includes a case where the access point enables a privacy separator function.

17. The method according to claim 1, wherein the predetermined cloud server system is formed by one or a plurality of server apparatuses.

18. An information processing apparatus comprising:
at least one memory storing instructions; and
at least one processor that is in communication with the at least one memory and that, when executing the instructions, cooperates with the at least one memory to execute processing, the processing including
executing first search processing as processing of searching for a communication apparatus belonging to a network formed by an access point to which the information processing apparatus is connected,
executing, based on a fact that no communication apparatus is discovered by the first search processing, second search processing as processing of searching for a registered communication apparatus in a predetermined cloud server system capable of communicating via the Internet, and
executing, via communication with the predetermined cloud server system, communication with a communication apparatus discovered by the second search processing.

19. A non-transitory computer-readable storage medium that stores one or more programs including instructions, which when executed by one or more processors of an information processing apparatus, cause the information processing apparatus to:
execute first search processing as processing of searching for a communication apparatus belonging to a network formed by an access point to which the information processing apparatus is connected;
execute, based on a fact that no communication apparatus is discovered by the first search processing, second search processing as processing of searching for a registered communication apparatus in a predetermined cloud server system capable of communicating via the Internet; and
execute, via communication with the predetermined cloud server system, communication with a communication apparatus discovered by the second search processing.
